(19) United States
(12) Patent Application Publication
(10) Pub. No.: US 2019/0347529 A1
(43) Pub. Date: Nov. 14, 2019

(54) PACKET CLASSIFICATION METHOD AND DEVICE

(71) Applicant: Tsinghua University, Beijing (CN)

(72) Inventors: Zhi Liu, Beijing (CN); Shijie Sun, Beijing (CN); Hang Zhu, Beijing (CN); Jiaqi Gao, Beijing (CN); Jun Li, Beijing (CN)

(21) Appl. No.: 15/974,004

(22) Filed: May 8, 2018

(51) Int. Cl. G06K 9/62; G06F 17/30; G06F 9/30; H04L 12/26

(52) U.S. Cl. CPC G06K 9/6282; H04L 43/0876; G06F 9/30018; G06F 17/30946

(57) ABSTRACT

A packet classification method includes building a decision tree with a preset building method for a packet, extracting packet header bits indicated by the bitmask of current node and concatenating the bits to generate a child index, traversing the child nodes recursively according to the child index until the leaf node is reached, obtaining in the reached leaf node a list of rule pointers referring to rules, and matching each of the rules so as to classify the packet. The method improves upon the current trade-off, and achieves faster classification speed while retaining reasonable memory consumption. A device for packet classification can implement the method.

### FIELD OF TECHNOLOGY

The present disclosure relates to the technical field of network communications, and particularly to a packet classification method and device.

### BACKGROUND

Packet classification is one of the essential techniques required by various network management functionalities, such as ACL (Access Control List), QoS (Quality of Service), FW (Firewall), IDS/IPS (intrusion detection and prevention) and so on. Given a group of pre-determined rules, the mission of packet classification is to identify the matching rule for each input packet.

The existing packet classification algorithms accomplish the mission geometrically by decomposing rule space recursively and building a decision tree for fast search. However, the existing packet classification algorithms are not efficient enough since they sacrifice either classification speed or memory size.

For example, algorithms such as HiCuts and HyperCuts can generate a large number of identical nodes due to fine-grained cuttings, such duplication leads to a considerable memory footprint and might even exceed the memory limit. While algorithms such as HyperSplit, sacrifice classification speed by conducting binary cuttings along the boundaries of the rules which are evenly distributed among the child nodes of a balanced binary tree.

Therefore, it will be necessary to come up with a method which can efficiently classify the packets without excessive memory consumption.

### SUMMARY

In order to solve the existing defects in the prior art, the present disclosure provides a packet classification method, comprising:
building a decision tree with a preset building method for a packet;
wherein the decision tree includes a root node comprising a plurality of child nodes, the child nodes are divided into leaf nodes and non-leaf nodes, wherein each non-leaf node comprises a plurality of leaf nodes and/or non-leaf nodes; wherein each node in the decision tree comprises a bitmask indicating one or more bits in the packet;
extracting packet header bits indicated by the bitmask of current node and concatenating the bits to generate a child index;
traversing the child nodes recursively according to the child index until the leaf node is reached;
obtaining in the reached leaf node a list of rule pointers referring to rules, and matching each of the rules so as to classify the packet.

Wherein the preset building method comprises:

checking whether a rule number of a ruleset is below a threshold value;
initializing the leaf node containing the rules in the ruleset if the rule number of the ruleset is below the threshold value.

Wherein if the rule number of the ruleset is above the threshold value,

obtaining a bit number of cutting bits according to BSS and arranging them in corresponding bitmasks;
dividing the rules into 2^{bit number} buckets, wherein each of the bucket correspond to a set of rules;
and, iterating through each of the buckets and recursively building the child nodes.

Wherein traversing the child nodes recursively according to the child index comprises:

accessing the root node and generating the child index;
accessing the child nodes of the root node indicated by the index and recursively traversing the descendant nodes until a leaf node is reached and a list of rule pointers is obtained.

Wherein matching each of the rules so as to classify the packet comprises:

matching the rules referred by the rule pointers with packet header value;
checking matched rules and outputting the matched rule having a highest priority as classification result.

In addition, the present disclosure further provides a packet classification device, comprising:
one or more processors; a memory; and one or more modules stored in the memory, the one or more modules are configured to perform the following operations when being executed by the one or more processors:
building a decision tree with a preset building method for a packet;
wherein the decision tree includes a root node comprising a plurality of child nodes, the child nodes are divided into leaf nodes and non-leaf nodes, wherein each non-leaf node comprises a plurality of leaf nodes and/or non-leaf nodes; wherein each node in the decision tree comprises a bitmask indicating one or more bits in the packet;
extracting packet header bits indicated by the bitmask of current node and concatenating the bits to generate a child index;
traversing the child nodes recursively according to the child index until the leaf node is reached;
obtaining in the reached leaf node a list of rule pointers referring to rules, and matching each of the rules so as to classify the packet.

Wherein the processor is further configured to perform the following:

checking whether a rule number of a ruleset is below a threshold value;
initializing the leaf node containing the rules in the ruleset if the rule number of the ruleset is below the threshold value.

Wherein the processor is further configured to perform the following:

if the rule number of the ruleset is above the threshold value,
obtaining a bit number of cutting bits according to BSS and arranging them in corresponding bitmasks;
dividing the rules into 2^{bit number} buckets, wherein each of the bucket correspond to a set of rules;
and iterating through each of the buckets and recursively building the child nodes.

Wherein the processor is further configured to perform the following:

accessing the root node and generating the child index;
accessing the child nodes of the root node indicated by the index and recursively traversing the descendant nodes until a leaf node is reached and a list of rule pointers is obtained.

Wherein the processor is further configured to perform the following:

matching the rules referred by the rule pointers with packet header value;
checking matched rules and outputting the matched rule having a highest priority as classification result.

By traversing the child nodes recursively according to the child index, the present disclosure is able to discriminate the rules efficiently without excessive partitions, and therefore achieves lower decision-tree depth and reasonable memory consumption. Since the child index is generated by concatenating the packet header bits indicated by the bitmask of current accessing node, a fast child-node traversal is supported and an ultra-fast decision-tree traversal is enabled.

Therefore, compared with the existing packet classification algorithms, the present disclosure is able to improve upon the current trade-off, achieve faster classification speed while retaining reasonable memory consumption.

### BRIEF DESCRIPTION OF THE DRAWINGS

FIG. 1 is a flow chart of the packet classification method of an embodiment of the present invention;

FIG. 2 is one of the implementing algorithms of an embodiment of the present invention;

FIG. 3 is one of the implementing algorithms of an embodiment of the present invention;

FIG. 4 is one of the implementing algorithms of an embodiment of the present invention;

FIG. 5 is one of the implementing algorithms of an embodiment of the present invention.

### DESCRIPTION OF THE EMBODIMENTS

The specific implementing methods of the present disclosure are described in more detail hereinafter with reference to the accompanying drawings and embodiments. Obviously, the following embodiments are only a part but not all of the embodiments of the present disclosure. On the basis of the embodiments of the present disclosure, all other embodiments obtained without creative work by a person of ordinary skill in the art, shall be within the protection scope of the present disclosure.

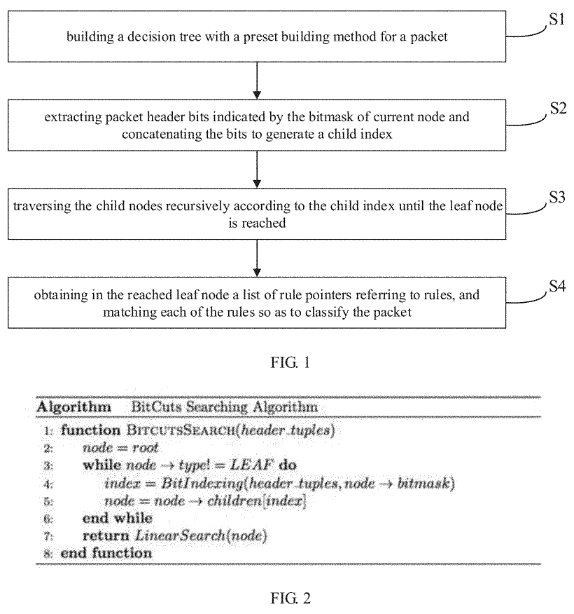

FIG. 1 is a flow chart of the packet classification method of an embodiment of the present invention, as shown in FIG. 1, the present disclosure provides a packet classification method, comprising:

S1. building a decision tree with a preset building method for a packet;
Wherein the decision tree includes a root node comprising a plurality of child nodes, the child nodes are divided into leaf nodes and non-leaf nodes, wherein each non-leaf node comprises a plurality of leaf nodes and/or non-leaf nodes; wherein each node in the decision tree comprises a bitmask indicating one or more bits in the packet;
S2. extracting packet header bits indicated by the bitmask of current node and concatenating the bits to generate a child index;
It needs to be noted that the current node refers to the node that is being accessed, the node could be the root node or the child node.
S3. traversing the child nodes recursively according to the child index until the leaf node is reached;
S4. obtaining in the reached leaf node a list of rule pointers referring to rules, and matching each of the rules so as to classify the packet.

It is understood by the person skilled in the art that the method may be implemented by various computers, such as desktop computer, tablet computer, laptop computers and the like.

Specifically, in an embodiment of the present disclosure, traversing the child nodes recursively according to the child index comprises:

accessing the root node and generating the child index;
accessing the child nodes of the root node indicated by the index and recursively traversing the descendant nodes until a leaf node is reached and a list of rule pointers is obtained.

In an embodiment of the present invention, S2-S3 may be performed with the algorithm as shown in FIG. 2.

Specifically, the function BitCutSearch( ) first accesses the root node, and calls BitIndexing( ) to calculate the index to the child node based on bitmask and header_tuples. BitIndexing( ) extracts the bits indicated by bitmask from header_tuples, and concatenates the bits to generate the child index, indicating the next node to traverse. This recursion continues until it reaches a leaf node and gets a list of rule pointers. Wherein, BitIndexing( ) is for generating the child index. One brute-force approach to bit indexing is to “shift and compare” to extract individual packet header bits and concatenate them to the child index.

In an embodiment of the present disclosure, bit indexing is implemented by a PEXT (Parallel Bits Extract) instruction. PEXT is included in the BMI2 instruction set, which was introduced with the Intel Haswell processor, and currently is supported by a wide range of processors. PEXT extracts arbitrary bit positions, as specified in bitmask. The instruction takes only 3 cycles and supports data length of 64 bits on Intel 64 architecture. For 5-tuple header (104 bits), the bit indexing takes up to 2 PEXT operations, which is far more efficient than “shift and compare” and enables fast lookup for the decision tree of the present disclosure.

In an embodiment of the present invention, the preset building method comprises:

checking whether a rule number of a ruleset is below a threshold value;
initializing the leaf node containing the rules in the ruleset if the rule number of the ruleset is below the threshold value.

And if the rule number of the ruleset is above the threshold value,

dividing the rules into 2^{bit number} buckets, wherein each of the bucket correspond to a set of rules;
and, iterating through each of the buckets and recursively building the child nodes.

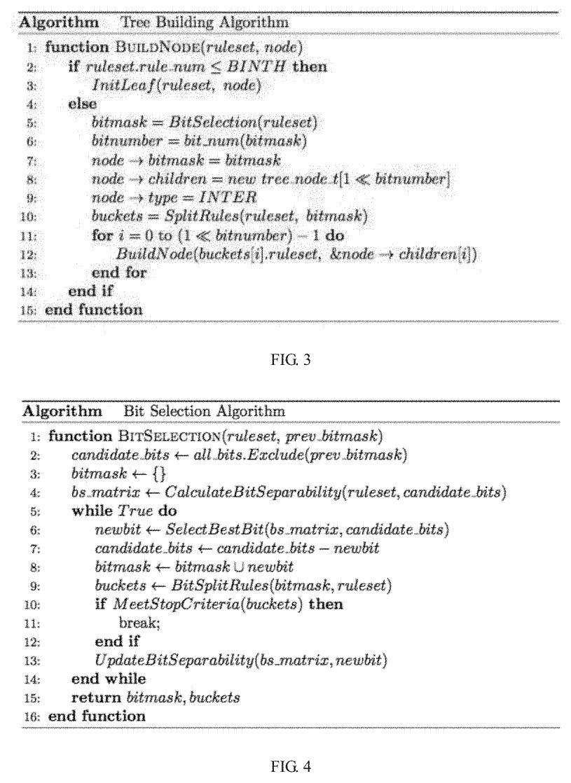

Specifically, as shown in FIG. 3, a feasible algorithm is proposed to build the decision tree.

Wherein, the function first checks whether the rule number in the ruleset is below a threshold BINTH. If so, a leaf node containing these rules is initialized. In cases where the rule number is above BINTH, the function first calls the bit-selection heuristic BitSelection( ) to acquire bit number of the ruleset. With the selected bits, SplitRules( ) divides the rules into 2^{bit number} buckets. Then the algorithm iterates through each of the buckets, and calls itself to recursively build the child node for the corresponding subset.

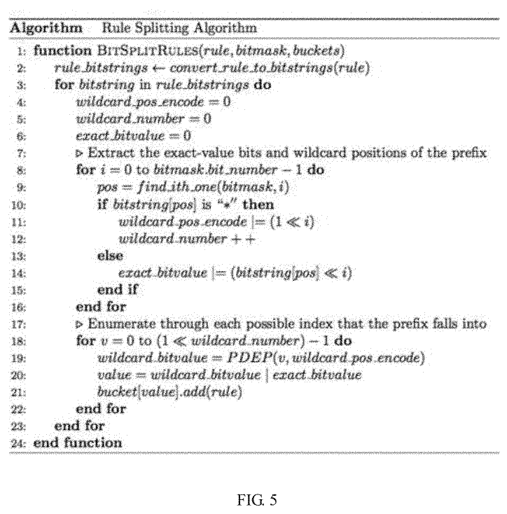

To be more specifically, the function heuristic BitSelection( ) may be implemented as in FIG. 4. The bit selection procedure could be analogized to a Set-Cover Problem.

Consider the ruleset R={Rᵢ, i=1 . . . . N}. A group of subsets S={S₁, S₂, . . . , S_{w}} has w elements, where Sᵢ is a set of rule pairs separated by Bi, representing the bit separability. The universe of the rule pairs is U={S₁∪S₂ . . . ∪Sₖ . . . ∪S_{w}, k=1, . . . , w}. Therefore, the bit selection procedure could be formulated as finding a minimum set of S so that all the elements of U are covered. According to the SCP formulation, ideally the selected bits should cover all of the rule pairs in U. However in the construction of a multi-layer decision tree, the bit selection should stop as the number of children grows excessively. Therefore, the actual bit selection algorithm is more complex and uses the SCP formulation as a heuristic for bit selection.

The algorithm initializes candidate_bits and bitmask, so that the bits included in the ancestor nodes are excluded from the current selection (Line 1-2). Then it calls CalculateBitSeparabilty( ), to calculate the BSS (Bit Separability Set) for each bit (Line 3). Afterwards, the algorithm enters the iteration to choose a number of bits in the bitmask, where each iteration picks one bit according to a greedy strategy. Inside the iteration, the algorithm examines the separability of each candidate bit, and adds the bit with the largest BSS to the bitmask (Line 6-8). The new bitmask is then used to split the ruleset into buckets (Line 9). With the buckets generated, the algorithm decides whether bit selection should stop by examining the stop criteria (Line 10). If any of the criteria is met, the algorithm returns bitmask together with buckets (Line 15); otherwise, it continues with the iteration. Since the added bit might separate some rules included in other separability sets, the algorithm updates the BSS of the other candidate bits before the next iteration. The update operation simply requires subtracting the pairs in the BSS of added bits from the BSSes of other candidate bits (Line 13).

As for the function SplitRules( ), it may be implemented as in FIG. 5.

Given the bitmask and a rule, the function BitSplitRule determines which of the child nodes the rule falls in. Since fields like IP addresses are represented by binary prefixes, we can easily get the corresponding bit value (0, 1, or *) in such fields. However, for range-based fields, it is nontrivial to derive the value for a certain bit position. Therefore, the algorithm BitSplitRule is designed as Algorithm 6.1 to tackle this problem.

The BitSplitRule algorithm first converts the input rule into a set of prefix-represented rules (PRR). Although the IP and Protocol fields are inherently prefixes, the port fields are specified by ranges, and can be expressed by multiple prefixes. Therefore, convert_rule_to_bitstrings first converts each rule into multiple PRR representations. Although this conversion increases the number of entries to split, these PRRs are shown as the original rule in the resulting buckets and do not introduce additional rule duplication.

With the bitmask and converted PRRs for the input rule, BitSplitRule then iterates through each PRR and determines all the buckets that the rule falls into. Note that the input rule falls in one bucket if any of its converted PRRs falls into it. Given m selected bit positions, the number of buckets is 2^{m}. A brute-force solution is to check each of the 2^{m} buckets and see if the selected bit values of a prefix cover the index value, which has the complexity of O(2^{m}). An optimization is made to cut down the overall complexity. The algorithm checks the prefix at the selected bit positions and extracts the exact-value part, as well as the wildcard part. Then it enumerates all the possible values of the wildcard part and combines the result with the exact-value part. In this way, the complexity is determined by the wildcard length of most rules, which is generally low, since the majority of rules are exact rules or rules with small ranges. To enumerate the values of the wildcard positions, another bit-level instruction-PDEP-is used to generate different values. PDEP is the reverse of PEXT. PDEP scatters the lower-order bits into positions specified in wildcard_pos_encode, and has the same cost (3 cycles) as PEXT, therefore dramatically accelerates the procedure.

Specifically, in an embodiment of the present disclosure, matching each of the rules so as to classify the packet comprises:

matching the rules referred by the rule pointers with packet header value;
checking matched rules and outputting the matched rule having a highest priority as classification result.

It is understood by the person skilled in the art that, given a group of pre-defined rules, the task of packet classification is to identify the matching rule for each input packet.

For example, each rule R contains d header field specifications, R[1], R[2] . . . R[d], each written in prefix or range representation. Typical header fields include source IP (SIP), destination IP (DIP), transport layer protocol (PROTO), source port (SP) and destination port (DP), etc. An incoming packet matches the rule only if each corresponding packet header field H[1], H[2] . . . H[d] matches the rule specification R[1], R[2] . . . R[d]. Each R contains a Priority and an Action. If multiple rules match the input packet, the one with the highest priority is returned and the associated Action is applied.

According to the method provided by the present disclosure, by traversing the child nodes recursively according to the child index, the present disclosure is able to discriminate the rules efficiently without excessive partitions, and therefore achieves lower decision-tree depth and reasonable memory consumption. Since the child index is generated by concatenating the packet header bits indicated by the bitmask of current accessing node, a fast child-node traversal is supported and an ultra-fast decision-tree traversal is enabled. Therefore, compared with the existing packet classification algorithms, the present disclosure is able to improve upon the current trade-off, achieve faster classification speed while retaining reasonable memory consumption.

The present disclosure also provides a packet classification device, comprising: one or more processors; a memory; and one or more modules stored in the memory, the one or more modules are configured to perform the following operations when being executed by the one or more processors:

building a decision tree with a preset building method for a packet;
wherein the decision tree includes a root node comprising a plurality of child nodes, the child nodes are divided into leaf nodes and non-leaf nodes, wherein each non-leaf node comprises a plurality of leaf nodes and/or non-leaf nodes; wherein each node in the decision tree comprises a bitmask indicating one or more bits in the packet;
extracting packet header bits indicated by the bitmask of current node and concatenating the bits to generate a child index;
traversing the child nodes recursively according to the child index until the leaf node is reached;
obtaining in the reached leaf node a list of rule pointers referring to rules, and matching each of the rules so as to classify the packet.

Wherein the processor is further configured to perform the following:

checking whether a rule number of a ruleset is below a threshold value;
initializing the leaf node containing the rules in the ruleset if the rule number of the ruleset is below the threshold value.

Wherein the processor is further configured to perform the following:

if the rule number of the ruleset is above the threshold value,
obtaining a bit number of cutting bits according to BSS and arranging them in corresponding bitmasks;
dividing the rules into 2^{bit number} buckets, wherein each of the bucket correspond to a set of rules;
and, iterating through each of the buckets and recursively building the child nodes.

Wherein the processor is further configured to perform the following:

accessing the root node and generating the child index;
accessing the child nodes of the root node indicated by the index and recursively traversing the descendant nodes until a leaf node is reached and a list of rule pointers is obtained.

Wherein the processor is further configured to perform the following:

matching the rules referred by the rule pointers with packet header value;
checking matched rules and outputting the matched rule having a highest priority as classification result.

By traversing the child nodes recursively according to the child index, the present disclosure is able to discriminate the rules efficiently without excessive partitions, and therefore achieves lower decision-tree depth and reasonable memory consumption.

Since the child index is generated by concatenating the packet header bits indicated by the bitmask of current accessing node, a fast child-node traversal is supported and an ultra-fast decision-tree traversal is enabled. Therefore, compared with the existing packet classification algorithms, the present disclosure is able to improve upon the current trade-off, achieve faster classification speed while retaining reasonable memory consumption.

Finally, it should be noted that the embodiments described above are merely for describing the technical solutions of the present disclosure, but not for limiting the protection scope thereof. Although the present disclosure is described in detail with reference to the embodiments above, it should be appreciated by those of ordinary skill in the art that it is still possible to modify the technical solutions described in the foregoing embodiments, or to equivalently substitute some or all of the technical features therein; and these modifications or substitutions do not separate the essence of corresponding technical solutions from the scope of the technical solutions within each embodiment of the present invention.

What is claimed is:

1. A packet classification method, comprising:
building a decision tree with a preset building method for a packet;
wherein the decision tree includes a root node comprising a plurality of child nodes, the child nodes are divided into leaf nodes and non-leaf nodes, wherein each non-leaf node comprises a plurality of leaf nodes and/or non-leaf nodes; wherein each node in the decision tree comprises a bitmask indicating one or more bits in the packet;
extracting packet header bits indicated by the bitmask of current node and concatenating the bits to generate a child index;
traversing the child nodes recursively according to the child index until the leaf node is reached; and
obtaining in the reached leaf node a list of rule pointers referring to rules, and matching each of the rules so as to classify the packet.

2. The packet classification method of claim 1, wherein the preset building method comprises:
checking whether a rule number of a ruleset is below a threshold value;
initializing the leaf node containing the rules in the ruleset if the rule number of the ruleset is below the threshold value.

3. The packet classification method of claim 2, wherein if the rule number of the ruleset is above the threshold value,
obtaining a bit number of cutting bits according to BSS and arranging them in corresponding bitmasks;
dividing the rules into 2^{bit number} buckets, wherein each of the bucket correspond to a set of rules;
and, iterating through each of the buckets and recursively building the child nodes.

4. The packet classification method of claim 3, wherein traversing the child nodes recursively according to the child index comprises:
accessing the root node and generating the child index;
accessing the child nodes of the root node indicated by the index and recursively traversing the descendant nodes until a leaf node is reached and a list of rule pointers is obtained.

5. The packet classification method of claim 4, wherein matching each of the rules so as to classify the packet comprises:
matching the rules referred by the rule pointers with packet header value;
checking matched rules and outputting the matched rule having a highest priority as classification result.

6. A packet classification device, comprising:
one or more processors; a memory; and one or more modules stored in the memory, the one or more modules are configured to perform the following operations when being executed by the one or more processors:
building a decision tree with a preset building method for a packet;
wherein the decision tree includes a root node comprising a plurality of child nodes, the child nodes are divided into leaf nodes and non-leaf nodes, wherein each non-leaf node comprises a plurality of leaf nodes and/or non-leaf nodes; wherein each node in the decision tree comprises a bitmask indicating one or more bits in the packet;
extracting packet header bits indicated by the bitmask of current node and concatenating the bits to generate a child index;
traversing the child nodes recursively according to the child index until the leaf node is reached;
obtaining in the reached leaf node a list of rule pointers referring to rules, and matching each of the rules so as to classify the packet.

7. The packet classification device of claim 6, wherein the processor is further configured to perform the following:
checking whether a rule number of a ruleset is below a threshold value;
initializing the leaf node containing the rules in the ruleset if the rule number of the ruleset is below the threshold value.

8. The packet classification device of claim 7, wherein the processor is further configured to perform the following:
if the rule number of the ruleset is above the threshold value,
obtaining a bit number of cutting bits according to BSS and arranging them in corresponding bitmasks;
dividing the rules into 2^{bit number} buckets, wherein each of the bucket correspond to a set of rules;
and, iterating through each of the buckets and recursively building the child nodes.

9. The packet classification device of claim 8, wherein the processor is further configured to perform the following:
accessing the root node and generating the child index;
accessing the child nodes of the root node indicated by the index and recursively traversing the descendant nodes until a leaf node is reached and a list of rule pointers is obtained.

10. The packet classification device of claim 9, wherein the processor is further configured to perform the following:
matching the rules referred by the rule pointers with packet header value;
checking matched rules and outputting the matched rule having a highest priority as classification result.
